(19) United States
(12) Patent Application Publication
(10) Pub. No.: US 2004/0255051 A1
(43) Pub. Date: Dec. 16, 2004

(54) System for controlling a workflow

(76) Inventors: Masahiro Abe, Kawasaki (JP); Hiromasa Shobatake, Yokohama (JP); Yuichi Mori, Kawasaki (JP); Yuji Kakutani, Yokohama (JP); Akihito Ito, Yokohama (JP); Atsushi Hasegawa, Tokyo (JP); Teruhisa Ishikawa, Tokyo (JP)

Correspondence Address: MCDERMOTT, WILL & EMERY, 600 13th Street, N.W., Washington, DC, 20005-3096, US

(21) Appl. No.: 10/813,429

(22) Filed: Mar. 31, 2004

(30) Foreign Application Priority Data
May 21, 2003 (JP) 2003-142839

(51) Int. Cl. G06F 17/00

(52) U.S. Cl. 710/1

(57) ABSTRACT

A plurality of branches having a plurality of terminal units and a plurality of financing devices, and a computation center are provided. An AP server in the computation center includes a plurality of device-related components that give control instructions of financing devices, a plurality of upper access components for enabling the use of plural types of work systems, a plurality of work-related component described as work logics and a component flow management unit to call such components in sequence. By enabling the component flow control unit to call the components in sequence according to the call sequence of component flow definition information that is defined in advance, an application for branch work is realized on the side of the AP server.

### BACKGROUND OF THE INVENTION

The present invention relates to a system, method and program for controlling a workflow of a branch including plural types of operation units and plural types of processing devices therein by using the operation units and the processing devices for the customer visiting the branch. In particular, the invention relates to a system used in banking facilities.

The Japanese Patent Laid-open No. 2002-91780 presents a method for calling work components in sequence by providing a plurality of work components, a workflow method which is a program to call a plurality of work components to a server and a workflow class which is a program to store a workflow method required for each work process.

Various types of financing devices exist in a bank branch, and a series of workflows including not only a screen operation, but also operation procedures of such financing devices are defined as clerical workflows.

However, the prior art only refers to calling of components stored in a server node in sequence, and it does not particularly refer to a physical layout and device managing method.

For future branch systems, it is demanded to achieve diversified work including control of financing devices from each terminal unit in a series of clerical workflows of respective branches with the minimum configuration of financing device.

### SUMMARY OF THE INVENTION

Taking the above into consideration, it is an object of the present invention to provide a system, etc. for improving operation efficiency of operation terminal units and processing devices by generalizing the operation terminal units which issue instructions to processing devices located in a branch.

It is another object of the present invention to provide a system, etc. for improving work efficiency in maintaining or customizing control functions and thus reducing workload of users, by centralizing control functions of processing devices located in a branch to a computation center.

It is still another object of the present invention to provide a system, etc. for improving efficiency in developing control functions, by centralizing control functions of processing devices in a branch and thus generalizing control terminal units which give instructions to the processing devices in the branch It is yet another object of the present invention to provide a system, etc. for downsizing a branch, by arranging control functions of processing devices in the branch in a computation center.

To accomplish the above objects, according to the present invention, a plurality of branches which have plural types of operation terminal units (e.g., terminal units at reception desk, terminal units at lobby, terminal units at counter, terminal units at back office and automated machines) operated by customers or sales persons and plural types of processing devices (e.g., scanners, voucher printers, cash deposit/withdrawal machines and passbook issuing machines), servers accessible by input operations from the control terminal units in branches, and a computation center which has plural types of work systems accessible from the server as required are connected via a network. The server comprises a terminal I/O control unit which accepts input data from operation terminal units and generates screens of operation terminal units, a plurality of device-related components for giving control instructions to processing devices located in branches, a plurality of upper access components for accessing various types of work systems available in the computation center, and a plurality of work-related components that are described as work logics in the server. The server executes branch work including control of processing devices by executing components available in the server in sequence according to input operations made at an operation terminal unit. At this time, the occupancy status of processing devices in the branch is controlled by the server, and the processing device operations are controlled according to instructions from the server. It should be noted, however, the server may be located in each branch depending on circumstances of banking facilities.

According to the present invention, it is preferable that a component flow control unit is provided within the server, and a component flow management unit that manages component flow definition information in which the component call order is defined and a component flow engine that calls component in sequence in accordance with the component flow definition information should be located in the component flow control unit. Thus, branch work is realized by customizing the component flow definition information. Here, to facilitate defining the component flow, a step of clerical work in the branch including input and output operations on the screen, operations of financing devices, and transmission and reception of data to and from a counting host are provided as a unit of component or method. Further, the component flow definition information enables to provide different flows for each branch and define a series of clerical workflows, including a plurality of screen switching operations, at a terminal unit.

According to the present invention, there is provided a storage device which stores process flow management information that defines process flows adequate for dealing with a request from an operation terminal unit, a terminal unit I/O control unit which controls inputs and outputs of data to and from the operation terminal unit, plural types of device management units (e.g., device-related components) which are provided, associated with the respective type of processing devices, and which control processing devices, and a flow control unit (e.g., a component flow control unit) which judges work pursuant to a request from each operation terminal unit, determines a process flow adequate for dealing with work by referring to the flow management information in the storage device, and determines the most adequate device management unit to be operated among plural types of device management units based on the process flow defined in the above.

According to the present invention, the work efficiency of operation terminal units and processing devices by centralizing control functions of the processing devices in a branch to a computation center so as to generalize the operation terminal units that give instructions to the processing devices in the branch, that is, by enabling an arrangement to give instructions to the processing devices from any terminal units without depending on types of processing devices.

Further, according to the present invention, by centralizing control functions of processing devices located in a branch to a computation center, maintenance or customization of the control functions can be executed intensively, thus improving work efficiency in maintenance or customization of the control functions and reducing workloads on a user.

Further, according to the present invention, efficiency in developing control functions can be improved by centralizing the control functions of processing devices in a branch to a computation center so as to generalize operation terminal units that give instructions to the processing devices in the branch.

Furthermore, according to the present invention, arrangement of control functions of processing devices in a branch in a computation center can downsize a branch.

### BRIEF DESCRIPTION OF THE DRAWINGS

FIG. 1 shows a configuration of a work control system;

FIG. 2 shows a format of data to be transmitted from a terminal unit during a transaction;

FIG. 3 shows a data example of a component flow management table managed by a component flow management unit;

FIG. 4 shows a data example of a component flow status management data managed by the component flow management unit;

FIG. 5 shows a data example of a device configuration definition table managed by a device management unit;

FIG. 6 shows a data example of a device status management data managed by the device management unit;

FIG. 7 shows process flows in each terminal unit;

FIG. 8 shows a process flow to call a component flow;

FIG. 9 shows a process flow to discriminate a component flow;

FIG. 10 shows a flow of device management process;

FIG. 11 shows a flow of component of a transaction for opening a new account at a terminal unit at counter;

FIG. 12 shows a process flow for opening a new bank account;

FIG. 13 shows a flow of component of a payment transaction at a terminal unit at counter; and

FIG. 14 shows a process flow of payment transaction.

### DETAIL DESCRIPTION OF THE PREFERRED EMBODIMENTS OF THE INVENTION

Hereinafter, preferred embodiments of the present invention will be described in detail with reference to the drawings.

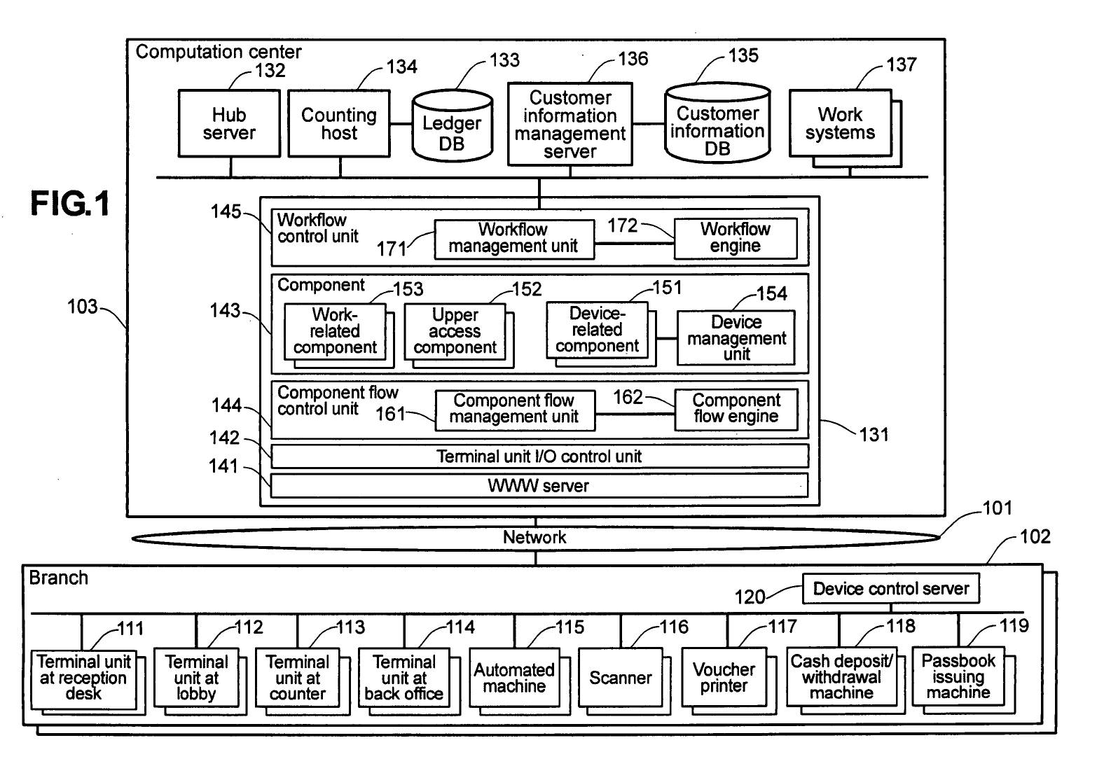

FIG. 1 shows a configuration of a work control system. A plurality of branches 102 to which customers make visits and a computation center 103 are connected to the system via a network 101.

A branch 102 is provided with terminal units including a terminal unit at reception desk 111 which is placed near the entrance of the branch and a customer visiting the branch is supposed to make a booking, a terminal unit at lobby 112 which allows a customer to make a transaction specific to the customer or a customer to freely operate the unit at the lobby during his or her wait time, a terminal unit at counter 113 which is operated by a bank clerk at the counter when the bank clerk deals with a customer directly, a terminal unit at back office 114 which is operated by a bank clerk in an exclusive area for bank clerks located to the back of the counter, and an automated machine which is operated by a customer, as is the case with an ATM, to complete a transaction. In addition, the branch 102 is also provided with financing devices implementing processing, including a scanner 116 which is used to convert a voucher filled in by a customer at the counter, an ID document brought in by a customer, etc. into image data and read the data, a voucher printer 117 which prints vouchers and also prints an authentication, a cash deposit/withdrawal machine 118 which is used to make a deposit or withdrawal of cash, and a passbook issuing machine 119 which is used to issue or enter a passbook. Further, the branch 102 is provided with a device control server 120 which controls the financing devices. In the device control server 120, middleware that controls the financing devices is installed. It should be noted that the device control server 120 may be arranged within the computation center 103 depending on the arrangement style of a bank or a branch. Further, functions of the device control server may be installed in each terminal unit located in the branch 102. Each terminal unit and each financing device are connected to the network 101 via a local area network (LAN) and a router. It is possible to directly control each terminal unit or each financing device from an AP server 131.

Further, the computation center 103 is provided with an AP server 131 in which an application for branch work according to the system of the present invention is mounted, a hub server 132 which is a via-device used when using each sub-system from the AP server 131, a counting host 134 which manages a ledger DB 133 where customers' account information, deposit, withdrawal and information on loans receivable and payable are recorded in a totalized form, a customer information management server 136 which manages various types of customer information DB 135, and plural types of work systems 137 which realize various types of work in the bank. Depending on situations of banks, an access may be made directly from the AP server 131 to another server or system without installing the hub server 132.

The AP server 131 includes therein a WWW server 141, a terminal unit I/O control unit 142 which controls input and output data to and from each terminal unit in the branch 102, a plurality of components 143 which should act as components to realize an application for branch work, a component flow control unit 144 which controls such components to be called in sequence, and a workflow control unit 145. Here, the WWW server 141 and the terminal unit I/O control unit 142 may be accommodated in a server other than the AP server 131. A component implies software (a program) to execute a desired process.

The component 143 includes a device-related component 151 which will act as a component to initiate financing devices in the branch 102, an upper access component which is used to access various types of work system such as the counting host 134, and a work-related component 153 which is executed only within the AP server 131. The device-related component 151 is provided for each type of the financing devices, and is connected to a device management unit 154 which controls information to define a financing device configuration and the present status thereof in each branch 102. The work-related component 153 checks input data from terminal units (for example, the numerical ranges and digit numbers of data and correlations between different data), and retrieves data stored in the AP server 131.

The component flow control unit 144 includes a component flow control unit 161 which controls information to define in which sequence the components 143 will be called according to a work pattern and the present status thereof, and a component flow engine 162 which calls the components 143 in sequence according to such information.

The workflow control unit 145 includes a work flow control unit 171 which controls status of each transaction and work data when a transaction is being made over a plurality of terminal units in each branch 102, and a workflow engine 172 which switches the status according to information on such status, work data, etc.

It should be noted that the components 143, the component flow control unit 144, and the workflow control unit 145 may be mounted on respective different servers. In addition, the various components in the component 143 may be mounted on respective different servers.

Functions of each control unit, each management unit, and each engine are achieved by a processor (e.g., CPU). Tables and management data are stored in a storage device (e.g., a hard disk drive). The processor can access the storage device to refer to tables in the storage device and read management data.

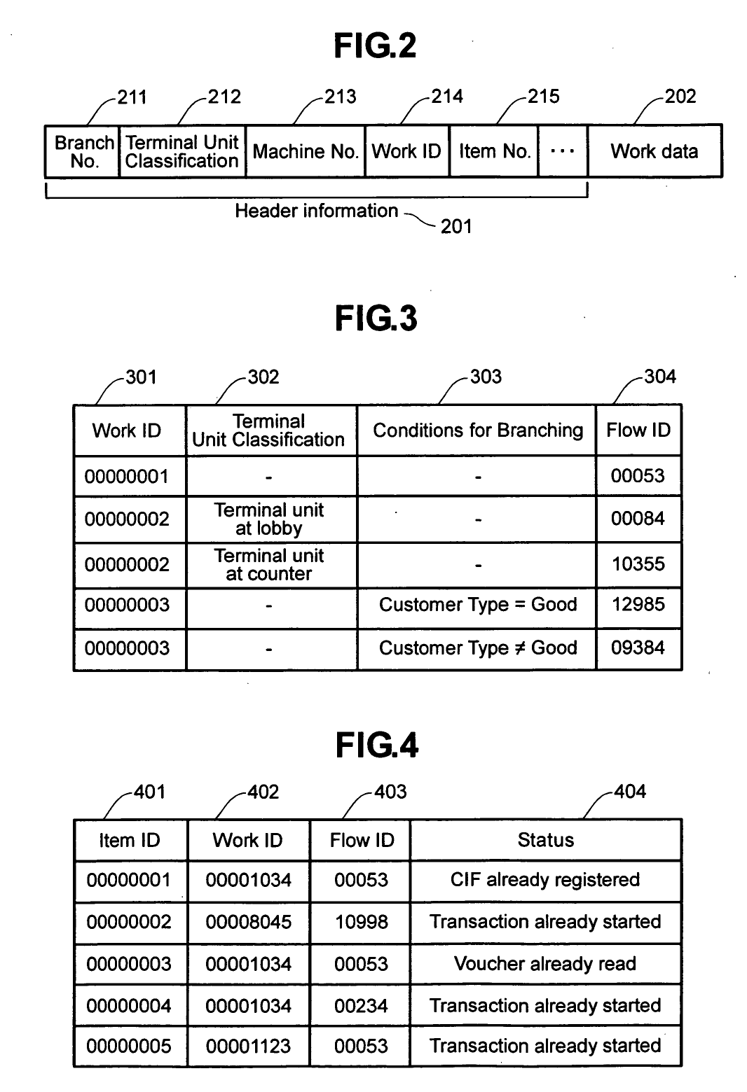

FIG. 2 shows a format of data to be transmitted to the AP server 131 in the computation center 103 from terminal units in the branch 102 when executing banking work. The format includes header information 201 which will be common information in respective work, and work data 202 which will be information defined individually for respective work. The header information 201 is configured with a branch No. 211 for uniquely identifying a branch to which a terminal unit to execute a certain work belongs, a terminal unit classification 212 for identifying types of terminal unit as to whether the terminal units executing the work is the terminal unit at lobby 112 or the terminal unit at counter 113, a machine No. 213 for uniquely identifying terminal units in the branch 102, a work ID 214 for identifying the work to be executed, an item ID 215 for uniquely identifying items being handled, etc.

FIG. 3 shows a component flow management table which is definition information to be managed by a component flow management unit 161 in the component flow control unit 144. The table includes a work ID 301 for uniquely identifying work, a terminal unit classification 302 for identifying classification of terminal units through which work is executed, conditions for branching 303 which will be defined when component flows used are subject to values of work data, and a flow ID 304 for identifying component flows. The table is used to acquire the flow ID 304 which shows the type of component flow to be used, by referring to the work ID 301, the terminal unit classification 302 contained in the data transmitted from a terminal unit shown in FIG. 2 and the conditions for branching 303 based on work data.

FIG. 4 shows component flow status management data which is to be managed by the component flow control unit 161 in the component flow control unit 144. The data includes an item ID 401 for uniquely identifying items, a work ID 402, a flow ID 403, and status 404 indicating in which flow status defined by the flow ID the present flow is. The item ID 401 is given in AP server 131 when data is transmitted to the AP server 131 for the first time from the terminal unit to be used initially in the case where a customer's transaction is executed. In addition, when it is necessary to hold a work status in the AP server 131, the server stores the present status 404 in the component flow status management data along with the item ID 401 indicating the item, the work ID 402 and the flow ID 403.

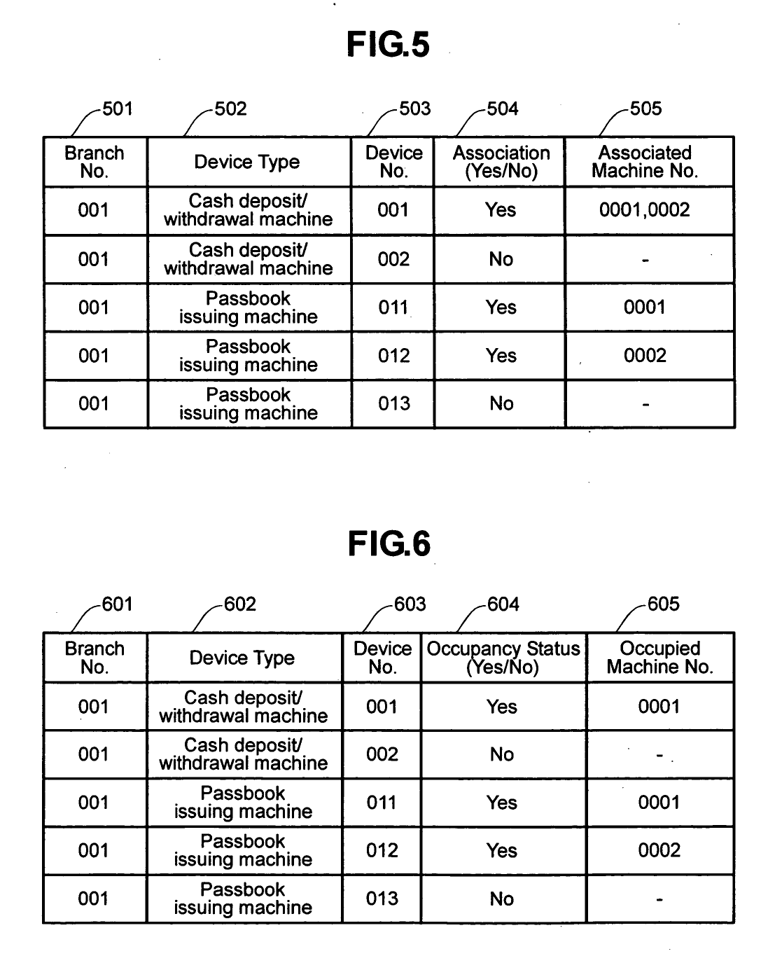

FIG. 5 shows a device configuration definition table which is definition information to be managed by a device management unit 154. The table contains a branch No. 501 for identifying the branch 102, a device type 502 for identifying types of financing devices, a device No. 503 for uniquely identifying financing devices in the branch 102, an association Yes/No 504 indicating whether a financing device has been associated with any terminal unit in advance or not, and an associated machine No. 505 showing with which terminal unit the financing device is associated, if the association has been made in the above. The status “associated” implies that an exclusive use has been defined. The association between a terminal unit and a financing device may be one to one, one to N (N is an integer 2 or larger), or N to one. In a certain financing device, where a terminal unit to use the device is defined in advance according to the device configuration of a branch, the terminal unit and the device should be associated with each other in advance. An example is that, when a passbook issuing machine 119 is installed next to the terminal unit at counter 113 and a passbook is entered at the counter at the terminal unit at counter 113, the passbook issuing machine 119 is used by all means. If a financing device is shared with various terminal units in the branch 102, the association Yes/No 504 should be defined to be “No”. It should be noted that the number of machine Nos. to be defined by an associated machine No. 505 is subject to the type of financing device.

FIG. 6 shows a device status management data managed by the device management unit 154 in the device-related component 151. The data includes a branch No. 601, a device type 602, a device No. 603, an occupancy status 604 which indicates whether or not a device is currently occupied by any terminal unit, and an occupied machine No. 605 which indicates by which terminal unit the device is occupied when the device is occupied. In the device status management data, the branch No. 601, the device type 602 and the device No. 603 are stored according to the device configuration definition table shown in FIG. 5, and data for the occupancy status 604 and the occupied machine No. 605 are updated by occupying or releasing the status in the course of practicing branch work.

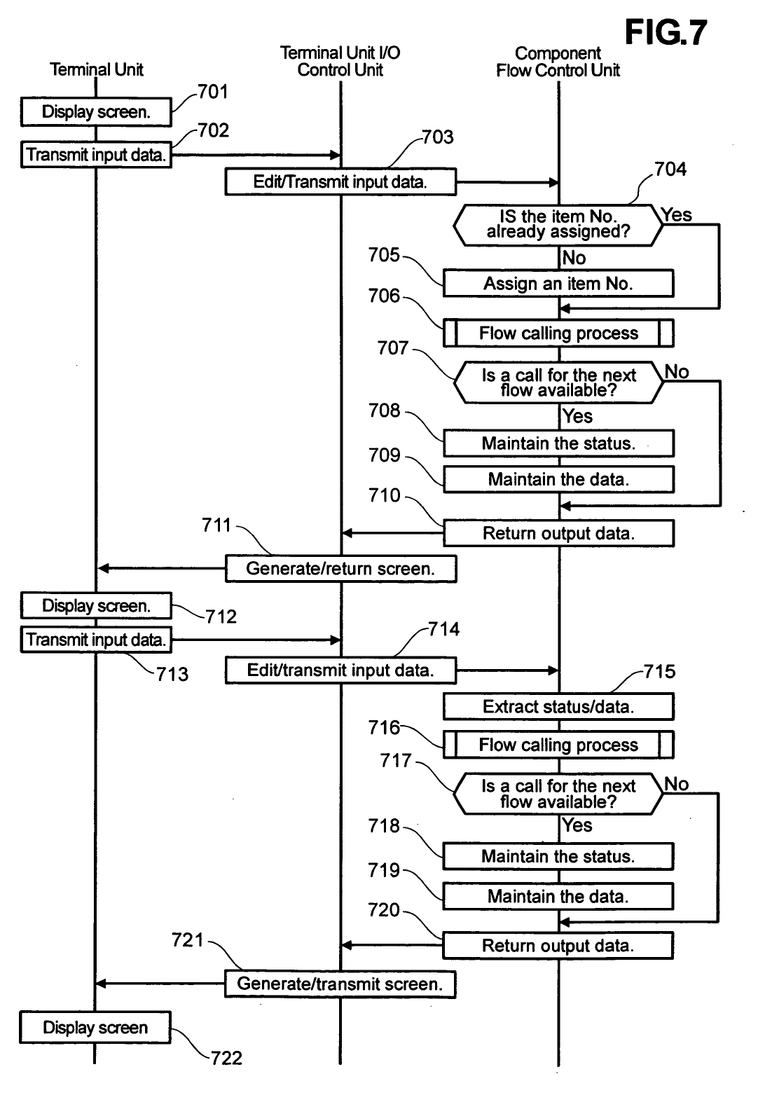

Next, detailed processing according to the present invention will be described with reference to FIGS. 7 to 10.

First, processing steps of work at each terminal unit in the branch 102 will be described with reference to FIG. 7. FIG. 7 describes steps to be executed respectively in terminal units such as the unit at lobby 112 and the unit at counter 113, the terminal unit I/O control unit 142 in the AP server 131, and the component flow control unit 144.

First, a screen is displayed on a terminal unit (Step 701). Necessary entries are made on the screen and the input data is transmitted to the AP server 131 (Step 702). Data format to be transmitted in Step 702 is shown in FIG. 2. The terminal unit I/O control unit 142 edits the input data received to a format specified by the component flow control unit 144 and transmits it to the component flow control unit 144 (Step 703).

In the component flow control unit 144, a judgment is made as to whether or not an item ID is given to an item transmitted (Step 704), and if the item ID is not given yet, the item ID is given to the item (Step 705). An item ID implies a number that is unique to each item under the system according to the present invention. The item is given for the first time during a system process and, therefore, the item is not initially stored in the data to be transmitted to the AP server 131 from a terminal unit. It should be noted, however, when a transaction is achieved over a plurality of terminal units, an item ID will have already been given when the remaining part of the transaction is achieved by the second terminal unit and thereafter.

Then, a flow call process is executed (Step 706) to call components in sequence according to the component flow definition information in which component flows are defined in sequence, and finally the process is executed.

Component flow definition information is referred to and then after displaying a screen, a judgment is made as to whether flow calls still remain or not (Step 707). If the flow calls remain, the present status in the flow is retained in the component flow status management data (Step 708), and necessary work data is kept (Step 709). A method for retaining the work data may be either of those methods including storage on DB, storage in the memory of the AP server 131, etc.

Next, the component flow control unit 144 returns output data to the terminal I/O control unit 142 (Step 710). The terminal I/O control unit 142 generates a screen based on the returned output data and returns the screen to the terminal unit (Step 711). The terminal unit displays the screen thereon (Step 712). When a transaction process still remains on the screen, Steps 713 to 722 are repeated in the same way as described above.

With the component flow to be defined with the present system, it is possible to define not only a range of flows that are called on the AP server 131 by a single request from a terminal unit, but also a series of workflows that include flows to be called on the AP server 131 for a plurality of times during switching of screens, as a result of switching of a plurality of screens, on a single terminal unit. With the present system, when data is transmitted for the second time and thereafter to the terminal unit from the AP server 131, continued process is executed according to the flow by retaining the status and work data in the flow in Steps 708 and 709.

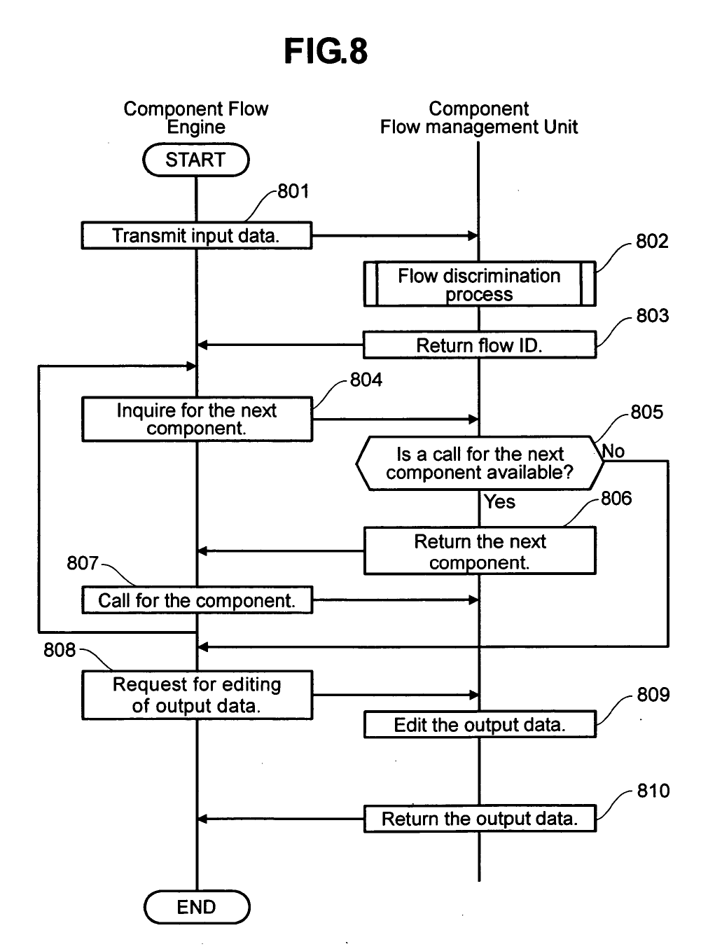

Next, processing steps of flow call process in Step 706 in FIG. 7 will be described with reference to the flow diagram in FIG. 8. FIG. 8 describes respective processes that are executed in the component flow engine 162 and the component flow management unit 161 in the component flow control unit 144.

To begin with, the component flow engine 162 transmits input data to the component flow management unit 161 (Step 801). The component flow management unit 161 discriminates a flow to be executed by referring to the input data received (Step 802), and returns its flow ID to the component flow engine 162 (Step 803).

Next, the component flow engine 162 inquires of the component flow management unit 161 a component to be called next (Step 804). The component flow management unit 161 judges whether or not the component to be called next is available (Step 805). If it is available, the component flow management unit 161 returns the adequate component to the component flow engine 162 (Step 806). The component flow engine 162 executes the process by calling the component (Step 807). When the execution of the component is completed, Steps 804 to 807 are repeated. If there is no component to be called further in Step 805, that is, if the flow is completed, the component flow engine 162 requests the component flow management unit 161 to edit output data (Step 808). The component flow management unit 161 edits the output data (Step 809) and returns it to the component flow engine 162 (Step 810).

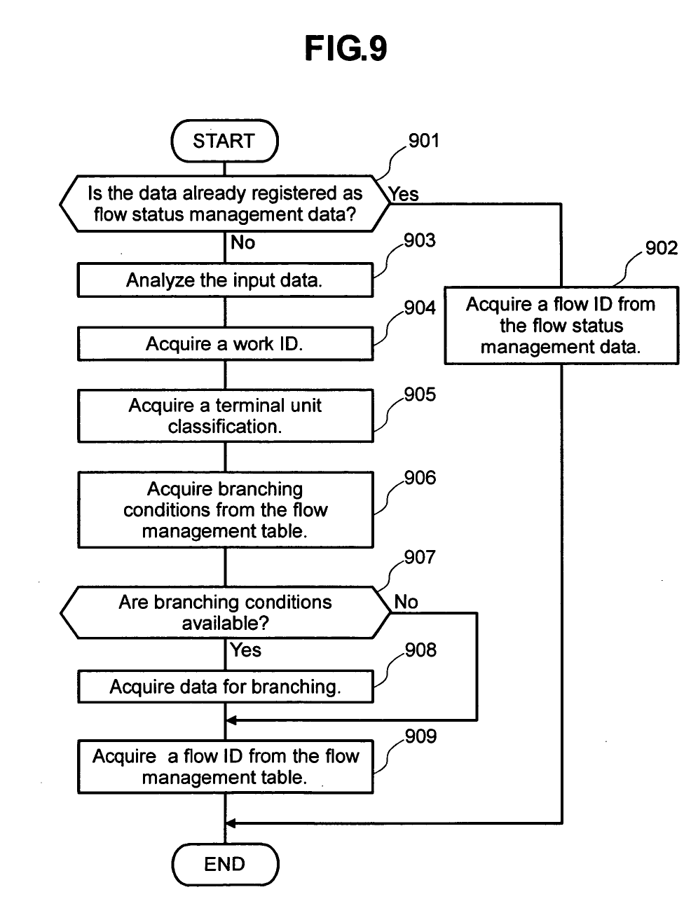

Next, processing steps of flow discrimination process in Step 802 in FIG. 8 will be described with reference to the flow diagram in FIG. 9.

First, by referring to an item ID in the transmitted input data, discrimination is made as to whether the item ID is already registered with the component flow status management data shown in FIG. 4 (Step 901). If the ID is already registered, the component flow management unit 161 acquires a flow ID from the component flow status management data (Step 902) before the process is terminated. If the ID is not registered yet, the following steps will be executed.

First, the input data is analyzed (Step 903), a work ID is acquired (Step 904) and a terminal unit classification is acquired (Step 905). Then, branching conditions are acquired based on the work ID and the terminal unit classification that are respectively acquired in Steps 904 and 905 by referring to the component flow administration table shown in FIG. 3 (Step 906). Discrimination is made as to whether certain conditions are described in the branching conditions acquired (Step 907). If the conditions are described, data required for branching is acquired from the input data (Step 908). Branching conditions are judged based on the data to acquire a flow ID from the component flow management table (Step 909).

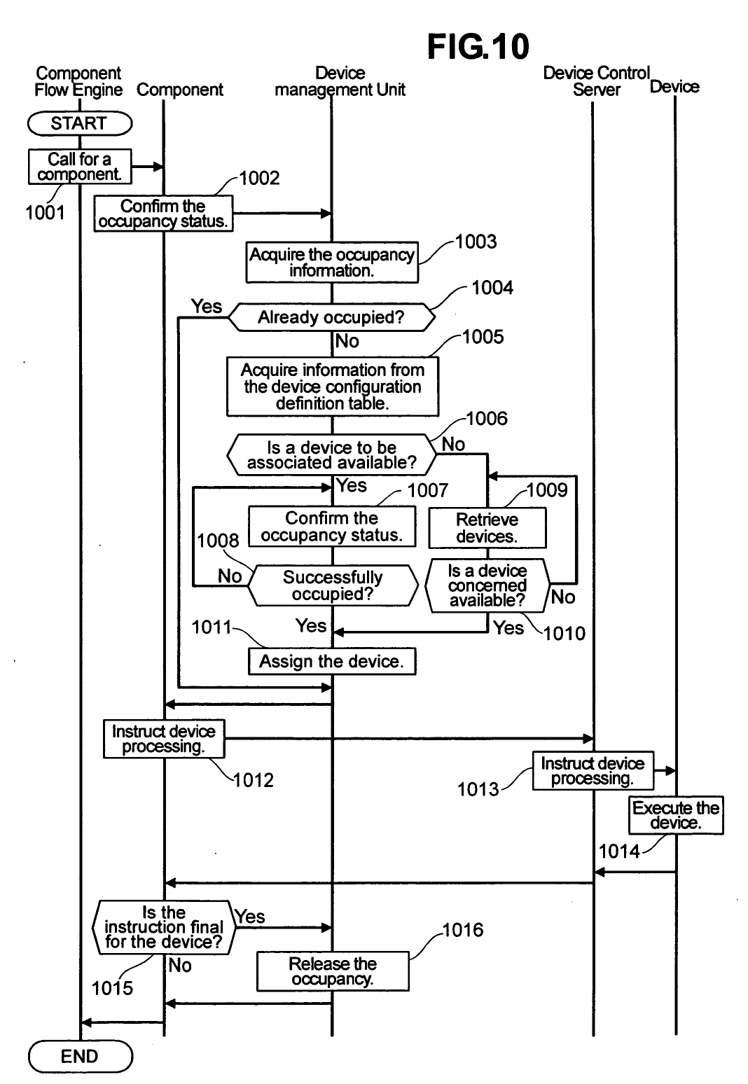

Next, with reference to the flow diagram in FIG. 10, processing steps of device management process to be executed when a device-related component is called from the component flow engine 162 will be described. FIG. 10 describes steps to be executed in the device-related component 151, the device management unit 154, the device control server 120 in the branch 102, and respective devices.

The component flow engine 162 calls the device-related component 151 (Step 1001). To occupy a financing device to be used, the device-related component 151 first inquires of the device management unit 154 whether the terminal has already occupied a certain financing device or not (Step 1002). In the device management unit 154, occupancy status information which indicates whether the terminal unit already occupied a financing device or not is acquired by referring to the occupancy status 604 and occupied machine No. 605 included in the device status management data (Step 1003). Based on the occupancy status information, judgment is made as to whether the financing device is already occupied or not (Step 1004). If the device is already occupied, the device management unit 154 returns the device No. of the financing device to the device-related component 151. If the device is not occupied yet, information as to whether the terminal unit is associated with the financing device of the type being used at the moment from the device configuration definition table (Step 1005). Then, judgment is made whether the associated device is available or not (Step 1006). If the device is associated, confirmation is made as to whether occupancy is possible by referring to the device status management table (Step 1007). When the occupancy is established (Step 1008), the financing device is allocated to the terminal unit by updating the occupancy status 604 and the occupied machine No. 605 in the adequate device field in the device status management data (Step 1011). If occupancy is not possible, a certain wait time is given, and by repeating Step 1007, wait time is given until occupancy becomes possible. In Step 1006, if no associated device is available, retrieving is made for a financing device whose occupancy status 604 in the device status management data is defined to be “No” out of those financing devices whose association Yes/No 504 is defined to be “No” among financing devices, in the device configuration definition table, whose branch No. 501 is defined to be the branch No. of the terminal unit (Step 1009). Then, a judgment is made as to whether an adequate financing device is available or not (Step 1010). If the device is available, the financing device is allocated in Step 1011. If no adequate financing device is available, a certain wait time is given, and by repeating Step 1009, wait time is given until occupancy becomes possible. After the financing device is allocated in Step 1011, the device management unit 154 returns the device No. of the adequate financing device to the component.

Then, the device-related component 151 delivers the device No. to the device control server 120 and instructs the server to execute processing of the financing device (Step 1012). The device control server instructs an adequate financing device to execute processing of the financing device (Step 1013), and thus the financing device operates (Step 1014).

After the operation of the financing device completes, the device-related component 151 judges whether the instruction for the processing of the device is the final instruction in the transaction at the terminal unit (Step 1015). If the instruction is final, the device management unit 154 cancels the occupancy (Step 1016). In Step 1016, the occupancy status 604 in the device status management data is updated to be “No”, and data of the occupancy machine No. 605 is deleted. It should be noted that, in Step 1015, if the instruction is not final, the occupancy will not be cancelled since the financing device is to be kept occupied without canceling the occupancy. For example, in the passbook issuing machine 119, when loading of a passbook is executed, the occupancy must not be cancelled since the passbook is kept in the passbook issuing machine 119 and another instruction will certainly occur at the same terminal unit.

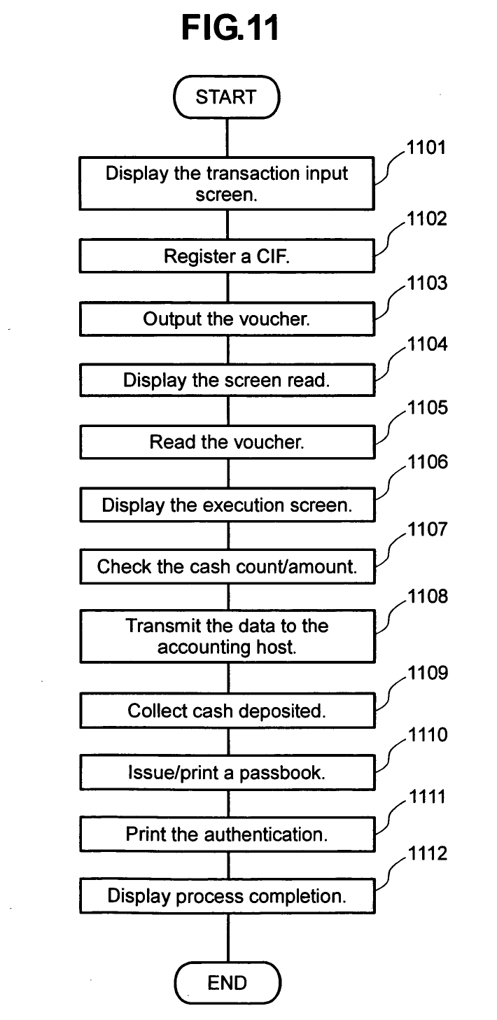

Next, detailed processes will be described specifically by referring to transaction examples of opening a new account and cash payment with reference to flow diagrams in FIG. 11 to 14. The preferred embodiment shows an example of a transaction at the terminal unit at counter 113.

First, the transaction example of opening a new account will be described.

FIG. 11 shows an example of a component flow for executing a transaction of opening a new account at the terminal unit at counter 113 after transaction data is inputted in advance at the terminal unit at lobby 112.

First, display of the transaction input screen is executed (Step 1101). After data is inputted, a CIF is registered with the counting host 134 (Step 1102), input data is output in the form of a voucher by using the voucher printer 117 (Step 1103), and the subsequent screen, or the instruction screen to read the voucher is displayed (Step 1104). Then, the voucher is read by using the scanner 116 (Step 1105), and the instruction screen to execute the counting host 134 is displayed (Step 1106). Then, cash inserted to the cash deposit/withdrawal machine 118 is counted and check is made as to whether the counted amount and the amount of the input data match or not Step 1107). When the two amounts match, data is transmitted to the counting host (Step 1108). Based on the result, deposited cash is collected by the cash deposit/withdrawal machine 118 (Step 1109), issuance and entry of the passbook are executed by the passbook issuing machine 119 (Step 1110), the authentication is printed by the voucher printer 117 (Step 1111), and a screen indicating process completion is displayed (Step 1112).

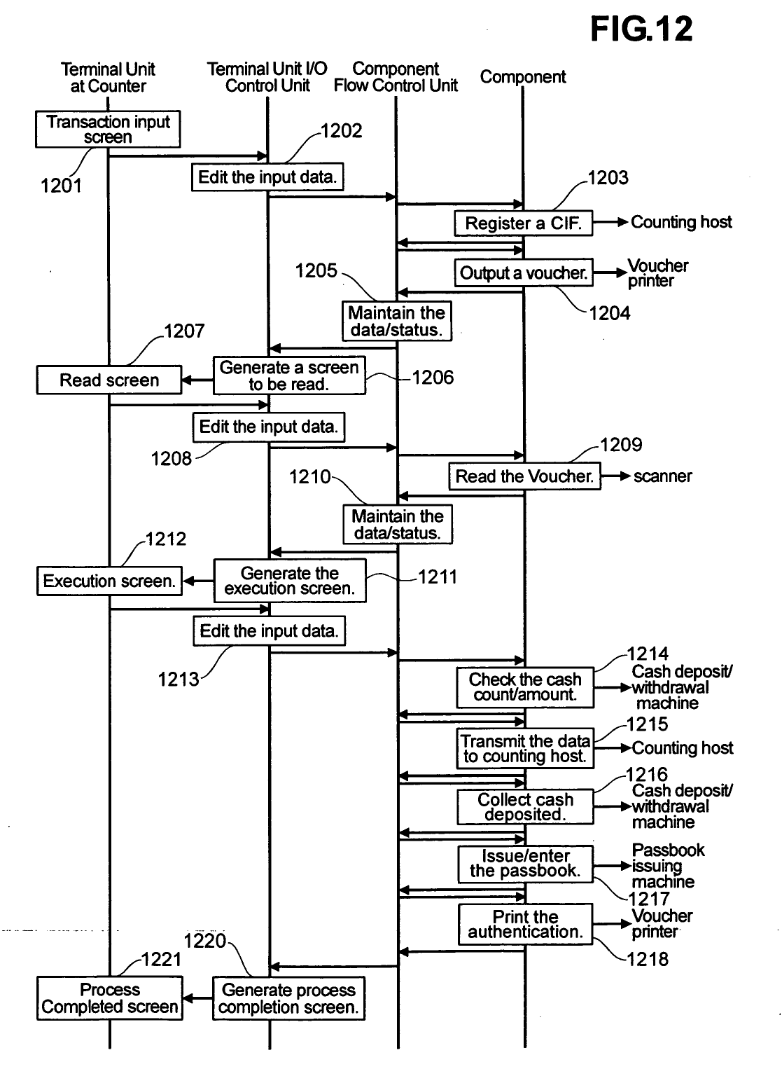

Hereinafter, process steps of a transaction for opening a new account according to the component flow shown in FIG. 11 will be described with reference to FIG. 12.

First, the terminal unit at counter 113 displays the transaction input screen which displays transaction data that is input in advance at the terminal unit at lobby 112 (Step 1201). When a bank clerk confirms the input data and depresses the “completion” button, the terminal unit at counter 113 transmits the input data to the AP server 131. In the AP server, the terminal unit I/O control unit 142 edits the input date (Step 1202), and delivers the data to the component flow control unit 144. The component flow control unit 144, pursuant to the component flow shown in FIG. 11, calls components in sequence according to the flow diagrams shown in FIGS. 7 to 9. In the example, a component to register a CIF is first called, and the component is transmitted to the counting host 134 (Step 1203). Next, a component to output a voucher is called, and the voucher is output to the voucher printer 117 (Step 1204). In the component flow shown in FIG. 11, since the read screen is subsequently displayed, calling of components is tentatively terminated here, data and status are retained in the component flow control unit 144 (Step 1205), and the output data is returned to the terminal unit I/O control unit 142. The terminal unit I/O control unit 142 generates the subsequent screen or the read screen based on the output data (Step 1206), and returns the read screen to the terminal unit at counter 113. Then, the terminal unit at counter 113 displays the read screen thereon (Step 1207).

Next, the bank clerk receives the voucher thus output, delivers the voucher to a customer, and asks the customer to place his or her seal on the voucher. Thereafter, the bank clerk receives the voucher with seal, ID documents such as a driver's license, and cash for deposit to open an account from the customer, thereby identifying the customer. Then, when the bank clerk sets the voucher on the scanner 116 and depresses the “Read” button on the read screen which is displayed on the terminal unit at counter 113, the input data is transmitted to the AP server 131. As is the case with Step 1202, the AP server edits the input data (Step 1208), and delivers the data to the component flow control unit 144. In the component flow control unit 144, since the data and the status are retained in Step 1205, the data and the status are acquired here, Step 1105 and thereafter of the component flow in FIG. 11 are executed, and the voucher is read by the scanner 116 (Step 1209). Since the process-completed screen is subsequently displayed, calling of components is tentatively terminated here, the component flow control unit 144 retains the data and the status again (Step 1210), and returns the output data to the terminal unit I/O control unit 142. The terminal unit I/O control unit 142 generates the subsequent screen or the process-completed screen based on the output data (Step 1211), and returns the process-completed screen to the terminal unit at counter 113 for displaying thereon (Step 1212).

Next, the bank clerk sets the cash received earlier in the cash deposit/withdrawal machine 118 and the voucher on the voucher printer 117, and depresses the “Completion” button on the process-completed screen which is displayed on the terminal unit at counter 113, whereby the input data is transmitted to the AP server 131. As is the case with Step 1202, the AP server edits the input data (Step 1213), and delivers the data to the component flow control unit 144. In the component flow control unit 144, since the data and the status are retained in Step 1210, the data and the status are acquired here, Step 1107 and thereafter of the component flow in FIG. 11 are executed, and components are called in sequence for cash counting and amount check (Step 1214), transmission to counting host (Step 1215), collection of deposited cash (Step 1216), issuance or entry of a passbook (Step 1217), and print of authentication (Step 1218) in this order. Since the process-completed screen is subsequently displayed and calling of components is tentatively terminated here, the output data is returned to the terminal unit I/O control unit 142. The terminal unit I/O control unit 142 generates the subsequent screen or the process-completed screen based on the output data (Step 1220), and returns the process-completed screen to the terminal unit at counter 113 to be displayed thereon (Step 1221). Then, the process is terminated.

Next, an example of payment transaction will be described.

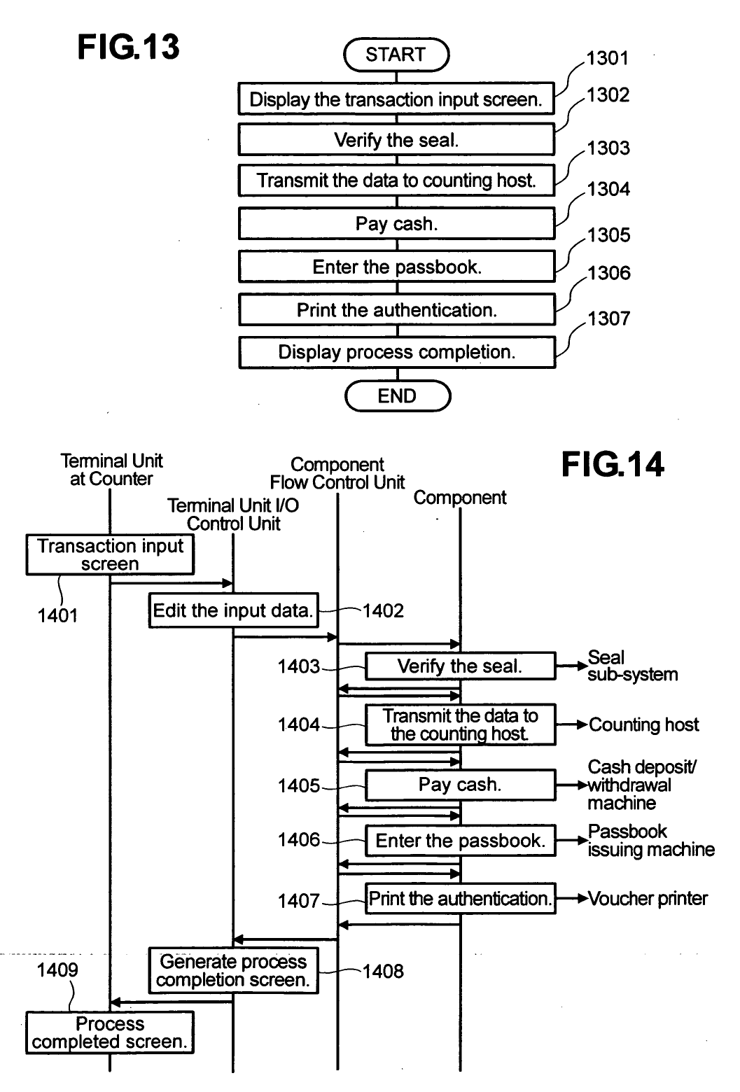

FIG. 13 shows an example of a component flow to execute a payment transaction at the terminal unit at counter 113 after the voucher is read in an image form by using a scanner at the counter.

First, display of the transaction input screen is executed (Step 1301). After data is inputted, seal verification is executed (Step 1302) and the data is transmitted to the counting host (Step 1303). Based on the result, cash is paid by the cash deposit/withdrawal machine 118 (Step 1304), entry of the passbook is executed by the passbook issuing machine 119 (Step 1305), authentication is printed by the voucher printer 117 (Step 1306), and a screen indicating process completion is displayed (Step 1307). The flow shown in FIG. 13 shows an example in which only one request is made from the terminal unit to the AP server 131.

Next, processing steps of a payment transaction being made according to the flow shown in FIG. 13 will be described with reference to FIG. 14.

First, the terminal unit at counter 113 displays thereon a transaction input screen displaying transaction data which is obtained by reading a voucher by the scanner 116 and recognizing characters on the voucher (Step 1401). When a bank clerk confirms the input data and depresses the “Completion” button, the input data is transmitted to the AP server 131. In the AP server 131, the terminal unit I/O control unit 142 edits the input data (Step 1402) and delivers it to the component flow control unit 144′. In the component flow control unit 144, pursuant to the component flow shown in FIG. 13, components are called in sequence according to the flow diagrams shown in FIGS. 7 to 9. In the example, a component for verifying seal is called first, and seal verification is made to the seal sub-system (Step 1403). Thereafter, the data is transmitted to the counting host 134 (Step 1404) and then, based on the result, components are called in sequence for cash payment (Step 1405), entry of passbook (Step 1406), and print of authentication (Step 1407) in this order. Since the process-completed screen is subsequently displayed and calling of components is tentatively terminated here, the output data is returned to the terminal unit I/O control unit 142. The terminal unit I/O control unit 142 generates the subsequent screen or the process completion screen based on the output data (Step 1408), and returns the process-completed screen to the terminal unit at counter 113 to be displayed thereon (Step 1409). Then, the process is terminated.

According to the embodiment of the present invention, cost reduction with the requisite minimum configuration of financing devices can be achieved, thus enabling versatile work including control of the financing devices from each terminal unit. Further, customization of application software necessitated by changes in branch workflow which are anticipated due to future diversification in work such as expansion of channels and new products can be facilitated.

According to another embodiment of the present invention, an arrangement to execute management of applications and devices enables the use of the present system from various terminal units and reduction of workload for maintaining the terminal units. Further, development of clerical work in a branch can be facilitated by providing, as component functions of the AP server, components wherein a step of clerical work in the branch is unitized into a component or a method, and offering a component flow control unit which calls such components in sequence.

It should be noted that the present invention is preferably applied to banking facilities. However, application of the present invention is not limited to banking facilities and is applicable to such systems that are used to manage a plurality of branches by a computation center.

What is claimed is:

1. A system for controlling a workflow, comprising:
plural types of operation terminal units that can be operated by a customer or a sales person;
plural types of processing devices;
a server to be accessed from said operation terminal units; and
a work system to be accessed from said server;
wherein said plural types of operation terminal units and said plural types of processing devices are installed in a branch, and said server and said work system are installed in a computation center; and
wherein said server comprises:
a terminal unit I/O control unit which executes a process to accept input data from said operation terminal units and a process to generate a screen to be displayed on said operation terminal units;
a first component for controlling said processing devices;
a second component for allowing said work system to be accessed; and
a plurality of third components for controlling work logics in said server.

2. A system according to claim 1, wherein said server executes said first component, said second component and said third component in response to input data from said operation terminal unit.

3. A system according to claim 2,
wherein said server includes a flow control unit for controlling a process flow by using said first, second and third components; and
wherein said flow control unit includes:
a management unit for managing definition information which defines the sequence of said first, second and third components; and
an engine for calling said first, second and third components in accordance with said definition information.

4. A system according to claim 3, wherein said definition information defines a series of workflows including switching of a plurality of screens to be displayed on said operation terminal units so that a different sequence for each of said branches can be provided.

5. A system according to claim 1,
wherein said first component includes management information for managing associations between said operation terminal units and said processing devices; and,
wherein each of said operation terminal unit defines a processing device to be used by each of said operation terminal units by referring to said management information.

6. A system for controlling a workflow, located outside a branch to which a customer makes a visit, which system is connected, via a network, to plural types of operation terminal units located in said branch and to plural types of processing devices located in said branch, said processing devices processing work according to a request from said operation terminal units, said system for controlling said workflow comprising:
a storage device which stores flow management information defining a processing flow for said work according to a request from said operation terminal units;
a terminal unit I/O control unit which controls inputs and outputs of data to and from said operation terminal units;
plural types of device management units which are provided for respective types of processing devices which controls said processing devices; and
a flow control unit which discriminates work according to a request from each of said operation terminal units, defines a processing flow satisfying said work by referring to flow management information in said storage device, and defines said device management unit to be operated out of said plural types of device management units based on said processing flow.

7. A system according to claim 6,
wherein said storage device stores information identifying a branch in which said processing devices are arranged; and
wherein said device management unit, by referring to the identification information on said branch stored in said storage device, selects a processing device installed in the same branch as the branch that made a request to said terminal unit I/O control unit, and controls said processing device thus selected.

8. A system according to claim 6,
wherein said storage device stores occupancy status information of said processing device; and
wherein said device management unit selects an unoccupied processing device by referring to said occupancy status information stored in said storage device, and controls said processing device thus selected.

9. A system according to claim 6,
wherein said storage device stores association information between said operation terminal units and said processing devices; and
wherein said device management unit judges whether or not a processing device is available which is associated with the operation terminal unit that made a request to said terminal unit I/O control unit, controls the processing device with which an association is established if said processing device is available, selects a processing device to be operated out of processing devices that are not associated if said processing device is not available, and controls said processing device thus selected.

10. A system according to claim 6, wherein said flow control unit selects a type of processing device to be operated according to said processing flow, and selects a device management unit which is adequate for the type of processing device to be subjected to said operation, out of said plural types of device management units, as the device management unit to be subjected to said operation.
